(19) United States
(12) Patent Application Publication
(10) Pub. No.: US 2023/0344121 A1
(43) Pub. Date: Oct. 26, 2023

(54) PHASE SHIFTER AND REMOTE ELECTRICAL TILT ANTENNA

(71) Applicant: HUAWEI TECHNOLOGIES CO., LTD., Shenzhen (CN)

(72) Inventors: Fuwei LEI, Xi’an (CN); Shaopu LV, Shenzhen (CN); Li JIN, Xi’an (CN); Maobin LI, Dongguan (CN)

(21) Appl. No.: 18/215,330

(22) Filed: Jun. 28, 2023

Related U.S. Application Data
(63) Continuation of application No. PCT/CN2020/142314, filed on Dec. 31, 2020.

(51) Int. Cl. H01Q 3/32; H01Q 1/24; H01P 1/18

(52) U.S. Cl. CPC H01Q 3/32; H01Q 1/246; H01P 1/184

(57) ABSTRACT

This application provides a phase shifter and a remote electrical tilt antenna. The phase shifter includes a metal stripline, a first dielectric plate and a second dielectric plate. The metal stripline is clamped between the first dielectric plate and the second dielectric plate. At least one limiting protrusion protrudes along a length direction on a surface of the first dielectric plate and/or the second dielectric plate facing the metal stripline. The at least one limiting protrusion is configured to limit displacement of the first dielectric plate and the second dielectric plate relative to the metal stripline when the first dielectric plate and the second dielectric plate slide. The phase shifter provided in this application enables the first dielectric plate and/or the second dielectric plate to slide exactly along the length direction of the metal stripline without deviation, thereby realizing accurate control of a phase change by the phase shifter.

### CROSS-REFERENCE TO RELATED APPLICATIONS

This application is a continuation of International Application No. PCT/CN2020/142314, filed on Dec. 31, 2020, the disclosure of which is hereby incorporated by reference in its entirety.

### TECHNICAL FIELD

This application relates to the field of communication technologies, and in particular, to a phase shifter and a remote electrical tilt antenna.

### BACKGROUND

A remote electrical tilt antenna of a base station implements down tilt adjustment of a beam of the base station antenna using a phase shifter, which makes the network coverage more flexible. The phase shifter is a core component of the base station antenna, and the performance of the phase shifter directly affects the overall performance of the antenna. Currently, a mainstream phase shifter in the industry changes a signal propagation rate by changing a dielectric constant around a feeder inside the phase shifter, to change a phase shift amount. Due to machining tolerances of various components in the phase shifter, there are differences in the coordination between the various components in the phase shifter, resulting in unstable performance of an antenna.

### SUMMARY

This application provides a phase shifter, to better ensure stability of an electrical performance of an antenna.

In an embodiment, a phase shifter includes a metal stripline, a first dielectric plate, and a second dielectric plate. The metal stripline includes a main body and a transmission section connected to the main body, and the metal stripline is clamped between the first dielectric plate and the second dielectric plate. The first dielectric plate and the second dielectric plate slide relative to the transmission section of the metal stripline along a length direction of the metal stripline. A limiting protrusion protrudes along the length direction on a surface of the first dielectric plate and/or the second dielectric plate facing the metal stripline. The limiting protrusion is located on a side portion of the metal stripline, and the limiting protrusion is configured to limit displacement of the first dielectric plate and the second dielectric plate relative to the metal stripline when the first dielectric plate and the second dielectric plate slide.

In an embodiment, a limiting protrusion is disposed on the first dielectric plate and/or the second dielectric plate, so as to limit displacement of the first dielectric plate and the second dielectric plate relative to the metal stripline when the first dielectric plate and the second dielectric plate slide. Therefore, the first dielectric plate and the second dielectric plate can slide along a width direction of the metal stripline without deviation, thereby realizing accurate control of phase change by the phase shifter.

In an embodiment of this application, when the first dielectric plate and the second dielectric plate slide relative to the metal stripline, the limiting protrusion moves along the side portion of the metal stripline, and an extension direction of the side portion is the same as the length direction.

In an embodiment, the limiting protrusion moves along the side portion of the metal stripline as the first dielectric plate and the second dielectric plate slide, and plays a guiding role for the movement of the first dielectric plate and the second dielectric plate, allowing the first dielectric plate and the second dielectric plate to slide along the side portion of the metal stripline, that is, the length direction of the metal stripline.

The limiting protrusion limits displacement of the first dielectric plate and the second dielectric plate relative to the metal stripline in the width direction, and the width direction is perpendicular to the length direction.

When the first dielectric plate and the second dielectric plate deviate relative to the metal stripline in the width direction, the limiting protrusion plays a blocking role, keeping the first dielectric plate always sliding along the length direction of the metal stripline, and avoiding deviating from the metal stripline in the width direction. In this way, the phase shifter can accurately implement phase change, and stability of electrical performance is not affected by differences in coordination of various components in the phase shifter.

In an embodiment, the limiting protrusion protrudes on the first dielectric plate, the limiting protrusion includes a body connected to the first dielectric plate and a limiting body located at an end portion of the body, the limiting body protrudes on one side of the body and extends towards the width direction, and the limiting body is located on a surface of the metal stripline facing away from the first dielectric plate. It may be understood that the metal stripline is stuck between the first dielectric plate and the limiting body in a height direction. The body defines a deviation of the first dielectric plate in the width direction, and the limiting body defines a deviation of the first dielectric plate in the height direction relative to the metal stripline.

In an implementation, a distance between the limiting protrusion and the side portion of the metal stripline is greater than 0 mm and less than or equal to 1 mm. In this way, there is a distance between the limiting protrusion and the side portion of the metal stripline, that is, the first dielectric plate is not in contact with the metal stripline, allowing the first dielectric plate and the second dielectric plate to slide smoothly along the metal stripline. In addition, the distance between the limiting protrusion and the side portion of the metal stripline is not too large, avoiding that the first dielectric plate and the second dielectric plate do not deviate relative to the metal stripline in the width direction when sliding.

Further, a plurality of limiting protrusions are provided, and the plurality of limiting protrusions are located on one side of the first dielectric plate and/or the second dielectric plate and disposed at intervals along the length direction. Alternatively, a plurality of limiting protrusions are located on two opposite sides of the first dielectric plate and/or the second dielectric plate and disposed in pairs. Alternatively, the plurality of limiting protrusions are located on two opposite sides of the first dielectric plate and/or the second dielectric plate and disposed in a staggered manner. In an implementation, a plurality of limiting protrusions are provided, and the plurality of limiting protrusions are located on two opposite sides of the first dielectric plate and/or the second dielectric plate and are disposed at intervals along the length direction, and are located on two opposite sides of the metal stripline. In this embodiment, the first dielectric plate and/or the second dielectric plate are provided with a plurality of limiting protrusions on two opposite sides of the metal stripline, that is, the metal stripline is located between the limiting protrusions of the two sides, so that neither the first dielectric plate nor the second dielectric plate deviates in a direction toward the two opposite sides in a width direction, which further limits deviation in a width direction of the first dielectric plate and/or the second dielectric plate relative to the metal stripline.

In an embodiment, the limiting protrusion protrudes on the first dielectric plate, a groove is provided on a surface of the second dielectric plate opposite to the first dielectric plate, the first dielectric plate is connected to the second dielectric plate, and the limiting protrusion extends into the groove and is held and fastened in the groove, or the limiting protrusion is a hook, the limiting protrusion protrudes on the first dielectric plate, a slot is provided on a surface of the second dielectric plate opposite to the first dielectric plate, the first dielectric plate is connected to the second dielectric plate, and the hook is held in the slot.

In an embodiment, the metal stripline includes a signal input terminal and a signal output terminal, the metal stripline is fastened in the cavity, and the transmission section is suspended in the cavity. The signal input terminal and the signal output terminal are configured to electrically connect to a cable outside the cavity, and the first dielectric plate and the second dielectric plate are disposed in the cavity and are movable relative to the transmission section of the metal stripline.

In an embodiment, a signal that needs to be radiated out is transmitted to the cavity via the signal input terminal, and is transmitted to the signal output terminal along the direction of the metal stripline via a medium in the cavity. When the first dielectric plate and the second dielectric plate slide relative to the metal stripline, an equivalent dielectric constant of a medium in a transmission section between the signal input terminal and the signal output terminal changes, so that the signal changes in a phase of a signal transmitted from the signal output terminal. Therefore, the radiated signal can be made to have a required phase by moving the first dielectric plate and the second dielectric plate.

In an embodiment, the transmission section includes a first transmission section and a second transmission section, a gap extending along the length direction is formed between the first transmission section and the second transmission section, and the gap is provided with an opening in the length direction. A buckle is disposed on the first dielectric plate, a slot is provided at a position of the second dielectric plate relative to the buckle, the buckle passes through the gap and is held in the slot, and the buckle slides in the gap, so that the first dielectric plate and the second dielectric plate slide in a same direction relative to the metal stripline. The first dielectric plate and the second dielectric plate are relatively fastened by disposing a buckle structure, so as to limit displacement in a height direction of the first dielectric plate and the second dielectric plate. The structure is simple and can conveniently control changes of displacement in a height direction of the first dielectric plate and the second dielectric plate relative to the metal stripline. It is important that a gap generated by the metal stripline is directly used as a guide groove for sliding the first dielectric plate and the second dielectric plate. The buckle can slide in the gap and play a guiding role, the first dielectric plate and the second dielectric plate can be guided without changing any structure for the strip line of irregular structure. Compared to existing technologies, the machining precision is improved, the structural complexity is reduced, the consistency and stability of the electrical performance are ensured, the performance of the phase shifter is further ensured, and the gap includes an opening, which is also very convenient in assembly.

In an embodiment, the first dielectric plate includes a first side surface and a second side surface, the second dielectric plate includes a third side surface and a fourth side surface, an abutting protrusion protrudes on each of the first side surface and the third side surface, the cavity includes two opposite cavity walls, the first dielectric plate and the second dielectric plate slide in the cavity, and the abutting protrusions slide along the cavity walls. A sliding trajectory of the first dielectric plate and the second dielectric plate in the cavity can be limited through the abutting protrusions, and a structure is simple, which can better ensure the performance of the phase shifter.

In an embodiment, the cavity includes a first sidewall and a second sidewall, opposite to each other and extending along the length direction of the metal stripline, two guide grooves are provided on each of the first sidewall and the second sidewall, and two opposite sides of the first dielectric plate are slidably mounted in one of the guide grooves on the first sidewall and the second sidewall, and two opposite sides of the second dielectric plate are slidably mounted in another guide groove on the first sidewall and the second sidewall. It may be understood that the guide groove is provided in the cavity, and the first dielectric plate and the second dielectric plate are mounted in the guide groove, so that the guide groove may play both a guiding role on the first dielectric plate and the second dielectric plate, and a limiting role on the first dielectric plate and the second dielectric plate.

The remote electrical tilt antenna includes a radiating element and the phase shifter, the radiating element is connected to the phase shifter, and an electromagnetic wave signal transmitted by the phase shifter is radiated out through the radiating element. Because the phase shifter provided in this application can perform phase shift control more accurately, the remote electrical tilt antenna has higher stability.

The phase shifter provided in this application is provided with a limiting protrusion on the first dielectric plate and/or the second dielectric plate of the phase shifter, which can limit displacement in a vertical sliding direction during the sliding process of the first dielectric plate and the second dielectric plate, and implement a guiding function of the sliding direction. Further, the consistency and stability of the electrical performance can be better ensured.

### BRIEF DESCRIPTION OF DRAWINGS

FIG. 1 is a schematic diagram of a structure of a phase shifter according to an embodiment of this application;

FIG. 2 is an exploded schematic diagram of a first dielectric plate, a second dielectric plate, and a metal stripline of the phase shifter shown in FIG. 1;

FIG. 3 is a schematic diagram of assembling of a first dielectric plate, a second dielectric plate, and a metal stripline of the phase shifter shown in FIG. 2;

FIG. 4 is a schematic diagram of assembling of a first dielectric plate and a metal stripline of the phase shifter shown in FIG. 2;

FIG. 5 is a cross-sectional view for which a first dielectric plate, a second dielectric plate, and a metal stripline of the phase shifter shown in FIG. 3 are assembled and mounted in a cavity shown in FIG. 1;

FIG. 6 is a schematic diagram of a structure formed by assembling a strip line and a first dielectric plate of a phase shifter according to another embodiment of this application;

FIG. 7 is a cross-sectional view for which a second dielectric plate of the phase shifter shown in FIG. 6 is assembled with a cavity;

FIG. 8 is a schematic diagram of a structure formed by assembling a strip line and a first dielectric plate of a phase shifter according to still another embodiment of this application;

FIG. 9 is a cross-sectional view for which a second dielectric plate of the phase shifter shown in FIG. 8 is assembled with a cavity; and

FIG. 10 is a cross-sectional view of a phase shifter according to an embodiment of this application.

### DESCRIPTION OF EMBODIMENTS

The following describes embodiments of this application with reference to the accompanying drawings in embodiments of this application.

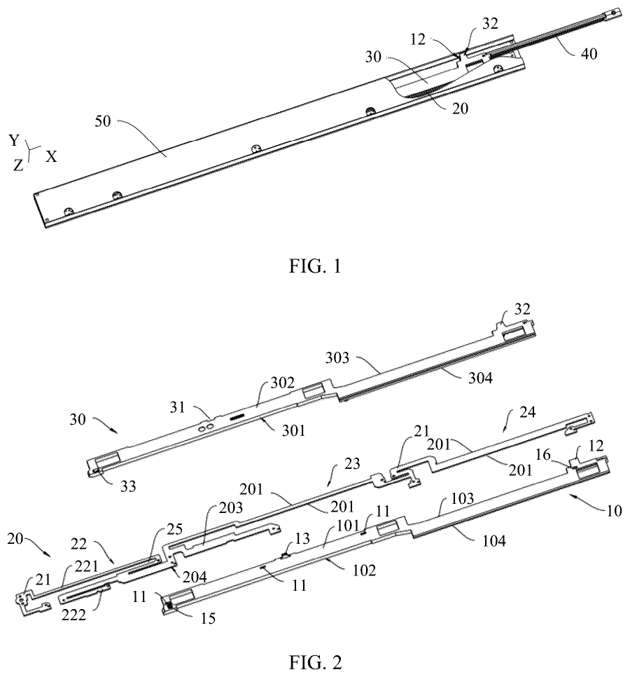

This application provides a remote electrical tilt antenna. The remote electrical tilt antenna includes a phase shifter 100 shown in FIG. 1 and a radiating element connected to the phase shifter 100 in a radio frequency manner. A signal that needs to be radiated out via the radiating element is changed to a required phase via the phase shifter 100, and then is radiated out via the radiating element. The radio frequency connection includes an electrical connection, a coupling connection, or the like. There may be one or more radiating elements, and a plurality of radiating elements are connected to a signal output port of the phase shifter 100 in a radio frequency manner. In this embodiment, the phase shifter 100 is in a long strip-shaped. In this embodiment, the radiating element is a radiating antenna. Further, the remote electrical tilt antenna may include one or more independent phase shifters 100, so as to meet an actual use requirement. The following explains the phase shifter 100 in this application by using a specific embodiment.

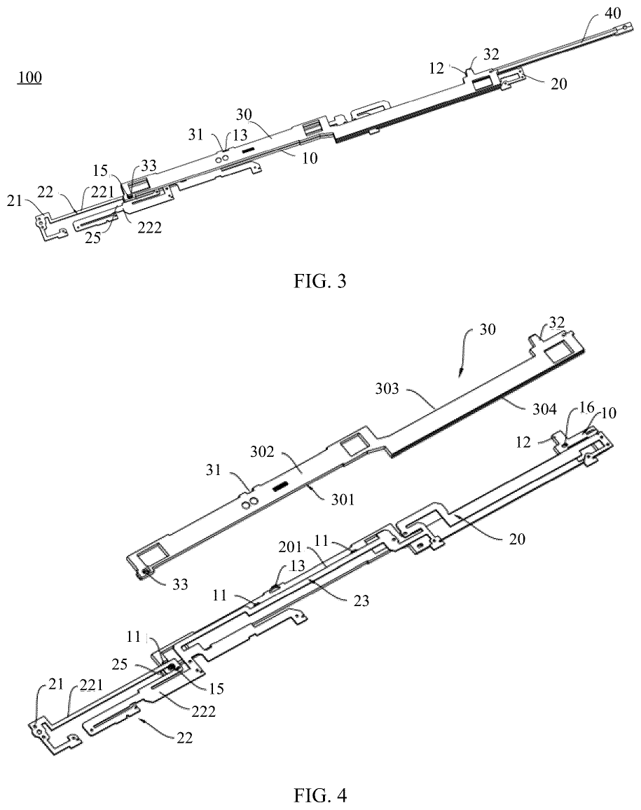

Referring to FIG. 2 and FIG. 3, in embodiments of this application, the phase shifter 100 includes a metal stripline 20, a first dielectric plate 10, and a second dielectric plate 30. The metal stripline 20 includes a main body 21 and a transmission section (not shown) connected to the main body 21. The metal stripline 20 is clamped between the first dielectric plate 10 and the second dielectric plate 30, and the first dielectric plate 10 and the second dielectric plate 30 may slide relative to the transmission section of the metal stripline 20 along a length direction of the metal stripline 20. At least one limiting protrusion 11 protrudes along the length direction on a surface of the first dielectric plate 10 and/or the second dielectric plate 30 facing the metal stripline 20. At least one of the limiting protrusions 11 is opposite to a side portion 201 of the metal stripline 20. At least one of the limiting protrusions 11 is configured to limit displacement of the first dielectric plate 10 and the second dielectric plate 30 relative to the metal stripline 20 when the first dielectric plate 10 and the second dielectric plate 30 slide. In a first embodiment of this application, a plurality of limiting protrusions 11 are disposed on the first dielectric plate 10. The length direction refers to an extension direction of the metal stripline 20 or a sliding direction of the first dielectric plate 10, specifically an X direction. A direction perpendicular to the length direction and on a same plane is a width direction, specifically a Y direction. A direction is perpendicular to the X and Y directions is a height direction Z. For details, refer to the following embodiments.

The signal is transmitted from one end of the metal stripline 20 to the other end of the metal stripline 20. The first dielectric plate 10 and the second dielectric plate 30 may slide relative to the transmission section of the metal stripline 20 along the length direction of the metal stripline 20, so as to change an area of the metal stripline 20 covered by the first dielectric plate 10 and the second dielectric plate 30. In this way, an equivalent dielectric constant of a medium in a transmission section through which the signal passes is changed, thereby changing power and a phase of a signal output from the metal stripline 20. The “transmission section through which the signal passes” refers to a signal transmission path of the signal on the metal stripline 20. The limiting protrusion 11 may limit positions of the first dielectric plate 10 and the second dielectric plate 30 relative to the metal stripline 20 in a direction perpendicular to a sliding direction, so that the dielectric plate can slide accurately in the length direction without width deviation. In addition, the first dielectric plate 10 and the second dielectric plate 30 can be guided, thereby realizing stability of the phase shifter 100 to a phase change.

Specifically, referring to FIG. 2, metal stripline 20 is a metal stripline structure of an irregular structure formed by processing a metal piece such as a metal wire or a metal plate. The metal stripline 20 includes an upper surface 203, a lower surface 204 opposite to the upper surface 203, and two opposite side portions 201. An extension direction of the side portion 201 is the same as the length direction of the metal stripline 20. The metal stripline 20 includes a plurality of transmission sections disposed at intervals. The plurality of transmission sections are connected via the main body 21, and the main body 21 may be an unconnected irregular sheet-like member. The transmission section is a portion that can output a signal, and the main body 21 is configured to fasten the transmission section and connect the first dielectric plate 10 and the second dielectric plate 30. The transmission section is a curved structure, for example, in a wave shape or a zigzag shape, formed by processing a metal wire or a metal plate. In this embodiment, by setting the metal stripline 20 as the curved structure, when a length of the metal line forming the metal stripline 20 is fastened, a length of the phase shifter 100 is shortened as much as possible, so that a volume of the phase shifter 100 can be reduced as much as possible, while a fine phase shift control can be implemented. It is convenient to integrate the phase shifter 100 with other structures. It should be noted that, in this embodiment, the transmission sections of the metal stripline 20 are a first partial transmission section 22, a second partial transmission section 23, and a third partial transmission section 24 that are arranged along the length direction. The side portions 201 of the first partial transmission section 22, the second partial transmission section 23, and third partial transmission section 24 jointly form the side portions 201 of the metal stripline 20. Upper surfaces and lower surfaces of the first partial transmission section 22, the second partial transmission section 23, and the third partial transmission section 24 jointly form the upper surface 203 and the lower surface 204.

Continuing to refer to FIG. 2, both the first dielectric plate 10 and the second dielectric plate 30 are strip-shaped plate structures. The first dielectric plate 10 includes a first surface 101 and a second surface 102 opposite to the first surface 101, and the first surface 101 is disposed opposite to the lower surface 204. The second dielectric plate 30 includes a third surface 301 and a fourth surface 302 opposite to the third surface 301. Referring to FIG. 3 together, in this embodiment, the first dielectric plate 10 and the second dielectric plate 30 are connected via a buckle structure, and the metal stripline 20 is located between the first dielectric plate 10 and the second dielectric plate 30. The first surface 101 of the first dielectric plate 10 faces the lower surface 204 of the metal stripline 20, and the third surface 301 of the second dielectric plate 30 faces the upper surface 203 of the metal stripline 20.

In an embodiment, as shown in FIG. 3 and FIG. 4, the plurality of limiting protrusions 11 protrude on the first surface 101 of the first dielectric plate 10, and the plurality of limiting protrusions 11 are disposed at intervals along the length direction on a same side of the first surface 101, as shown in FIG. 3. The limiting protrusion 11 is located on a side portion 201 of the metal stripline 20, that is, the limiting protrusion 11 is located on a side of the first dielectric plate 10 close to the side portion 201 of the metal stripline 20. In an embodiment, the plurality of limiting protrusions 11 are located on the side portions 201 of the first partial transmission section 22, the second partial transmission section 23, and the third partial transmission section 24, so that sliding displacement of the first dielectric plate 10 and the second dielectric plate 30 relative to the transmission section can be accurately limited. A surface of the limiting protrusion 11 facing the side portion 201 has a distance from the side portion 201, which can ensure that the limiting protrusion 11 does not affect sliding smoothness of the first dielectric plate 10 and the second dielectric plate 30, also ensure that the first dielectric plate 10 and the second dielectric plate 30 are limited in the width direction when sliding.

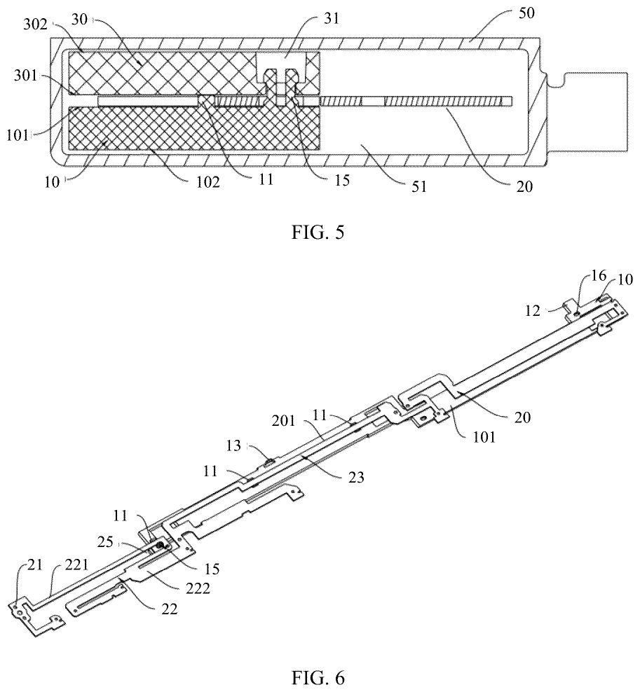

Still referring to FIG. 4 and FIG. 5, when the first dielectric plate 10 and the second dielectric plate 30 slide relative to the metal stripline 20, the plurality of limiting protrusions 11 move along the side portion 201 of the metal stripline 20, and the plurality of limiting protrusions 11 limit displacement of the first dielectric plate 10 and the second dielectric plate 30 relative to the metal stripline 20 in the width direction. In an embodiment, when the first dielectric plate 10 and the second dielectric plate 30 slide along the transmission section of the metal stripline 20, and in the length direction, that is, in the sliding direction, when the first dielectric plate 10 deviates in the width direction relative to the metal stripline 20, the plurality of limiting protrusions 11 can prevent the first dielectric plate from deviating from the metal stripline 20 in the width direction, so that the phase shifter 100 can accurately implement a phase change.

The plurality of limiting protrusions 11 move with the movement of the first dielectric plate 10 and the second dielectric plate 30. Because the limiting protrusions 11 can limit the displacement of the first dielectric plate 10 relative to the metal stripline 20 in the width direction, the limiting protrusions 11 do not deviate from the side portion 201 of the metal stripline 20. In this way, the limiting protrusions 11 move along with the first dielectric plate 10 along the side portion 201 of the metal stripline 20, so as to guide the movement of the first dielectric plate 10, so that the first dielectric plate 10 can slide along the metal stripline 20 within a tolerance range. It should be noted that when the first dielectric plate 10 slides, the second dielectric plate 30 slides along with the first dielectric plate 10 in the same direction, and the limiting protrusion 11 also limits the second dielectric plate 30.

In an embodiment, the displacement of the first dielectric plate 10 relative to the metal stripline 20 during sliding is limited by disposing the limiting protrusion 11 on the first dielectric plate 10, so that the first dielectric plate 10 and the second dielectric plate 30 can accurately slide on the metal stripline 20 without deviation. In this way, relative positions of the metal stripline 20 and the two dielectric plates can be controlled and a phase shift function can be implemented while guiding of the dielectric plates and limiting of the dielectric plates in the width direction are implemented. An over-fit gap generated between the dielectric plates and an over-fit gap between the dielectric plate and the metal stripline 20 due to a tolerance are reduced, and consistency and stability of electrical performance of the phase shifter 100 can be ensured. A plurality of limiting protrusions 11 are provided, and the plurality of limiting protrusions 11 are disposed along a side of the first dielectric plate 10, so that when the first dielectric plate 10 slides along the length direction of the metal stripline 20, the limiting protrusions 11 can simultaneously limit the first dielectric plate 10 at a plurality of positions, which further strengthens the limit of the displacement of the first dielectric plate 10 relative to the metal stripline 20 by the limiting protrusion 11. Certainly, there may alternatively be one limiting protrusion 11, and the limiting protrusion protrudes at a middle position of the first dielectric plate 10.

Further, a distance between the limiting protrusion 11 and the side portion 201 of the metal stripline 20 is greater than 0 mm and less than or equal to 1 mm. In this embodiment, the distance between the limiting protrusion 11 and the side portion 201 of the metal stripline 20 is 0.5 mm. In another embodiment, the distance between the limiting protrusion 11 and the side portion 201 of the metal stripline 20 may alternatively be greater than 0 mm and less than 0.5 mm, or greater than 0.5 mm and less than 1 mm. In this way, there is a distance between the limiting protrusion 11 and the side portion 201 of the metal stripline 20, that is, the first dielectric plate 10 is not in contact with the metal stripline 20, allowing the first dielectric plate 10 to slide smoothly along the metal stripline 20. In addition, the distance between the limiting protrusion 11 and the side portion 201 of the metal stripline 20 is not too large, avoiding that a deviation distance between the first dielectric plate 10 and the metal stripline 20 in the width direction is too large when the first dielectric plate slides.

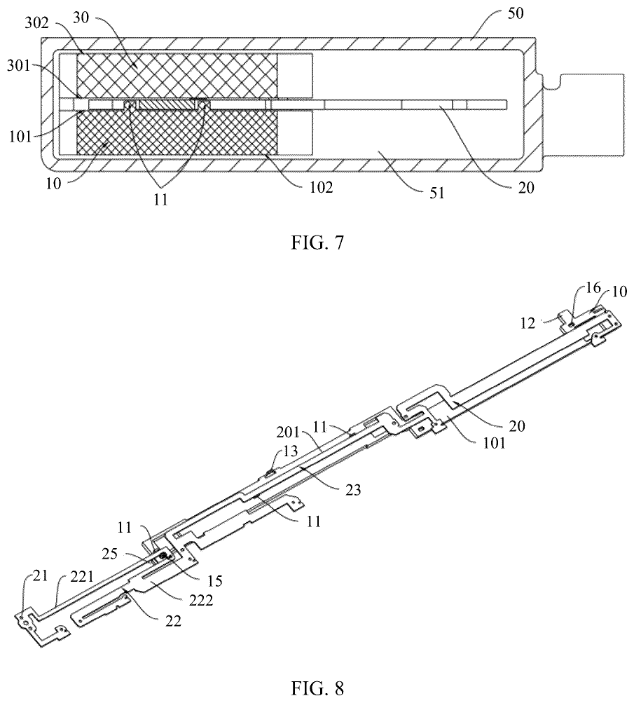

Referring to FIG. 6 and FIG. 7, in an embodiment, the plurality of limiting protrusions 11 protrude on two opposite sides of the first surface 101 of the first dielectric plate 10 and are disposed at intervals along the length direction, and are located at relative positions of the two opposite side portions 201 of the metal stripline 20. The metal stripline 20 is located between the limiting protrusions 11 on two sides. That is, the plurality of limiting protrusions 11 are disposed on the first surface 101 in pairs, and each pair of limiting protrusions 11 is respectively located on two sides of the first surface 101. The transmission section of the metal stripline 20 is located between a pair of limiting protrusions 11. When the first dielectric plate 10 slides relative to the metal stripline 20 in the length direction, the limiting protrusions 11 are in directions of the two opposite side portions 201 of the metal stripline 20, to limit the first dielectric plate 10. This enables the first dielectric plate 10 to slide exactly along the length direction of the metal stripline 20, and a deviation of the first dielectric plate 10 in the width direction relative to the metal stripline 20 is further limited.

Referring to FIG. 8, in another embodiment, the plurality of limiting protrusions 11 are distributed on two sides of the first surface 101, and are disposed in a staggered manner. In this way, a quantity of limiting protrusions 11 can be reduced, and displacement consistency of the first dielectric plate 10 can be ensured in an entire sliding process, thereby ensuring the stability of the phase shifter 100.

Further, when the transmission section of the metal stripline 20 is of a wavy structure (not shown), the wavy transmission section includes a plurality of convex portions and a plurality of concave portions, and the convex portions and the concave portion are disposed at intervals. The concave portion includes an opening, located between two convex portions adjacent to the concave portion. A size of the limiting protrusion 11 along the length direction is greater than a size of the opening along the length direction, so that the limiting protrusion 11 does not fall into it) the concave portion when the first dielectric plate 10 slides relative to the metal stripline 20, avoiding affecting sliding of the first dielectric plate in the length direction.

In an embodiment, the limiting protrusion 11 may alternatively be of a continuous strip-shaped structure (not shown), and the strip-shaped limiting protrusion 11 is disposed on the first dielectric plate 10 along the length direction. When the first dielectric plate 10 deviates from the metal stripline 20 in the width direction at any sliding position, the limiting protrusion 11 can limit a further deviation of the first dielectric plate 10 in time, and correct the first dielectric plate 10 to an original sliding track. In this way, the first dielectric plate 10 can slide along the length direction of the metal stripline 20 without deviation in the width direction. The limiting protrusion 11 is not limited to the shape described in this embodiment. The shape of the limiting protrusion can be changed, for example, a trapezoidal block or a ball, provided that performance and sliding of the dielectric plate are not affected.

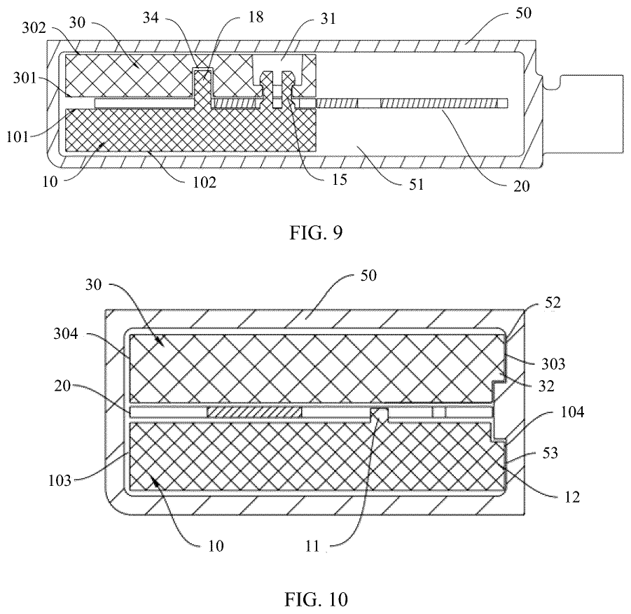

Referring to FIG. 9, in an embodiment, the limiting protrusion 18 protrudes on the first dielectric plate 10, a groove 34 is provided on a surface of the second dielectric plate 30 opposite to the first dielectric plate 10, and the first dielectric plate 10 is connected to the second dielectric plate 30. The limiting protrusion 18 extends into the groove 34 and is held and fastened in the groove 34. In another implementation, the limiting protrusion is a hook, the limiting protrusion protrudes on the first dielectric plate, a slot is provided on a surface of the second dielectric plate opposite to the first dielectric plate, the first dielectric plate is connected to the second dielectric plate, and the hook is held in the slot. The limiting protrusion is disposed on the first dielectric plate and extends into the second dielectric plate, so that the displacement of the first dielectric plate and the second dielectric plate in the width direction can be limited, and relative displacement between the first dielectric plate and the second dielectric plate and height displacement of the first dielectric plate and the second dielectric plate can be limited, thereby further ensuring sliding accuracy and achieving the stability of the electrical performance of the phase shifter.

A second embodiment of this application is not shown in the figure. A difference from the foregoing embodiment lies in that the plurality of limiting protrusions 11 protrudes on the third surface 301 of the second dielectric plate 30 along the length direction, and the plurality of limiting protrusions 11 are located on the side portion 201 of the metal stripline 20. The limiting protrusion 11 is configured to limit displacement of the second dielectric plate 30 relative to the metal stripline 20 when the second dielectric plate 30 slides. The second dielectric plate 30 slides relative to the metal stripline 20 along the length direction. When the second dielectric plate 30 deviates relative to the metal stripline 20 in the width direction, the limiting protrusion 11 plays a blocking role, so that the second dielectric plate 30 always slides along the length direction of the metal stripline 20 without deviation in width. When no limiting protrusion 11 is disposed on the first dielectric plate 10, the second dielectric plate 30 drives the first dielectric plate 10 to slide, which can also ensure a sliding trajectory of the first dielectric plate 10.

In an embodiment, the plurality of limiting protrusions 11 are disposed on a side of the second dielectric plate 30 at intervals along the length direction. That is, the plurality of limiting protrusions 11 may be located on a side of the second dielectric plate 30 close to a first side portion 201, or may be located on a side of the first dielectric plate 10 close to a second side portion 201. In some embodiments, the plurality of limiting protrusions 11 may alternatively be located on two opposite sides of the second dielectric plate 30 and disposed at intervals along the length direction, and are located on two opposite sides of the metal stripline 20. The metal stripline 20 is located between the limiting protrusions 11 on two sides, and the limiting protrusions can limit the second dielectric plate 30, so that the second dielectric plate 30 can accurately slide along the length direction of the metal stripline 20, to further avoid a deviation of the second dielectric plate 30 in the width direction relative to the metal stripline 20.

In a third embodiment of this application (not shown), a difference from the foregoing embodiment lies in that the limiting protrusions 11 are disposed on both the first dielectric plate 10 and the second dielectric plate 30. That is, the limiting protrusions 11 protrude on both the first surface 101 of the first dielectric plate 10 and the third surface 301 of the second dielectric plate 30 along the length direction, and the limiting protrusion 11 is located on the side portion 201 of the metal stripline 20. The limiting protrusion 11 is configured to limit displacement of the first dielectric plate 10 and the second dielectric plate 30 relative to the metal stripline 20 when the first dielectric plate 10 and the second dielectric plate 30 slide. In an embodiment, the limiting protrusion 11 limits the displacement of the first dielectric plate 10 and the second dielectric plate 30 relative to the metal stripline 20 in the width direction. The first dielectric plate 10 and the second dielectric plate 30 slide relative to the metal stripline 20 in the length direction. When the first dielectric plate 10 and the second dielectric plate 30 deviate relative to the metal stripline 20 in the width direction, the limiting protrusion 11 plays a blocking role, so that the metal stripline 20 is always located between the limiting protrusions 11 on two sides, and the first dielectric plate 10 and the second dielectric plate 30 do not deviate from the metal stripline 20 in width.

In an embodiment, when the first dielectric plate 10 and the second dielectric plate 30 slide relative to the metal stripline 20, the limiting protrusion 11 moves along the side portion 201 of the metal stripline 20. As the first dielectric plate 10 and the second dielectric plate 30 move along the side portion 201 of the metal stripline 20, the limiting protrusion 11 can guide the movement of both the first dielectric plate 10 and the second dielectric plate 30, so that the first dielectric plate 10 and the second dielectric plate 30 can smoothly slide along the length direction of the metal stripline 20.

In an embodiment, the plurality of limiting protrusions 11 may protrude on one side or two sides of the first surface 101 of the first dielectric plate 10, or may protrude on one side or two sides of the third surface 301 of the second dielectric plate 30. Alternatively, the limiting protrusions 11 on the first dielectric plate 10 and the second dielectric plate 30 may be located on two sides of the metal stripline 20. In some embodiments, the plurality of limiting protrusions 11 are located on two opposite sides of the first dielectric plate 10 and the second dielectric plate 30 and are disposed at intervals along the length direction, and are located on two opposite sides of the metal stripline 20. That is, the plurality of limiting protrusions 11 are disposed on the first dielectric plate 10 and the second dielectric plate 30 near the two side portions 201, and the metal stripline 20 is located between the limiting protrusions 11 on two sides. When both the first dielectric plate 10 and the second dielectric plate 30 are provided with the plurality of limiting protrusions 11 on the two sides of the metal stripline 20, the limiting protrusions 11 can limit both the first dielectric plate 10 and the second dielectric plate 30 in an X-axis positive direction and an X-axis negative direction, so that both the first dielectric plate 10 and the second dielectric plate 30 can accurately slide along the length direction of the metal stripline 20. This further limits deviations of the first dielectric plate 10 and the second dielectric plate 30 relative to the metal stripline 20 in the width direction.

In an embodiment of this application, the limiting protrusion 11 includes a body and a limiting body (not shown) located at an end portion of the body. The limiting body protrudes on one side of the body and extends towards the width direction. The limiting body is located on a surface of the metal stripline 20 facing away from the first dielectric plate 10.

Specifically, the first embodiment in which the limiting protrusion 11 is disposed on the first dielectric plate 10 is used as an example. The limiting protrusion 11 protrudes on the second surface 102 of the first dielectric plate 10, the body protrudes on the second surface 102, and the other end is connected to the limiting body. The limiting body is away from one side of the body and located on the lower surface 204 of the metal stripline 20. That is, the metal stripline 20 is stuck between the first dielectric plate 10 and the limiting body in a height direction. When the first dielectric plate 10 slides along the length direction of the metal stripline 20, the limiting body prevents the first dielectric plate 10 from deviating in the height direction and displacing in the width direction relative to the metal stripline 20. This further enables the first dielectric plate 10 to slide along the length direction of the metal stripline 20 more accurately. The “height direction” herein refers to a direction perpendicular to the surface of the metal stripline 20.

It may be understood that the limiting protrusion 11 in this embodiment may be further disposed on the second dielectric plate 30, or may be disposed on both the first dielectric plate 10 and the second dielectric plate 30. When the limiting protrusion 11 is disposed on the second dielectric plate 30, the body is connected to the second dielectric plate 30, and the limiting body is located on a surface of the metal stripline 20 facing away from the second dielectric plate 30. That is, the limiting body is away from one side of the body and located on the upper surface 203 of the metal stripline 20, and the metal stripline 20 is stuck between the second dielectric plate 30 and the limiting body in the height direction. The body of the limiting protrusion 11 limits a deviation of the second dielectric plate 30 in the width direction, and the limiting body limits a deviation of the second dielectric plate 30 relative to the metal stripline 20 in the height direction. When the limiting protrusions 11 are disposed on both the first dielectric plate 10 and the second dielectric plate 30, the limiting protrusion 11 on the first dielectric plate 10 simultaneously limits deviations of the first dielectric plate 10 relative to the metal stripline 20 in the width direction and the height direction. The limiting protrusion 11 on the second dielectric plate 30 simultaneously limits deviations of the second dielectric plate 30 relative to the metal stripline 20 in the width direction and the height direction.

Referring to FIG. 3, FIG. 4, and FIG. 5, in an embodiment of this application, the first dielectric plate 10 and the second dielectric plate 30 are connected via a buckle 15 and may slide relative to the metal stripline 20. The first partial transmission section 22 of the transmission section includes a first transmission section 221 and a second transmission section 222, a gap 25 extending along the length direction is formed between the first transmission section 221 and the second transmission section 222. The buckle 15 is disposed on the first dielectric plate 10. A slot 33 is provided at a position of the second dielectric plate 30 opposite to the buckle 15. The buckle 15 passes through the gap 25 and is held in the slot 33. The buckle 15 slides in the gap 25, so that the first dielectric plate 10 and the second dielectric plate 30 slide relative to the metal stripline 20 in the same direction. In this embodiment, the gap 25 is provided with an opening in the length direction, and during assembly, the opening facilitates assembly of the buckle 15 and the metal stripline 20. In an embodiment, the buckle 15 protrudes at an end portion of the first dielectric plate 10. In this embodiment, the buckle 15 at one end is used for description. The buckle 15 includes two buckle bodies (not shown). Each of the buckle bodies includes a connection section and a hook protruding from the connection section. The two buckle bodies are disposed adjacently and the buckle 15 has opposite orientations. The connection section has elasticity, to facilitate mounting in the slot 33 of the second dielectric plate 30. The connection section passes through the gap 25 of the metal stripline 20 and extends into the slot 33 and is held in the slot 33. When the first dielectric plate 10 and the second dielectric plate 30 slide, the connection section slides in the gap 25 to implement sliding displacement of the first dielectric plate 10 and the second dielectric plate 30. In this embodiment, the first dielectric plate 10 is fastened through the buckle 15, and sliding is implemented via a structure of the metal stripline 20, which saves the assembly structure, saves the process without changing any structure, and does not affect the performance of the metal stripline 20.

Further, a single buckle body also protrudes on one side of the first dielectric plate 10, and a side edge of the second dielectric plate 30 corresponding to the buckle body forms an opening groove toward the inside of the dielectric plate. The buckle body is buckled on the opening groove and does not interfere with the metal stripline 20. Disposition of the buckle 15 and the buckle body can fasten the first dielectric plate 10 and the second dielectric plate 30, and in particular, can define a consistency between a length direction and a height direction.

Referring to FIG. 1, the phase shifter 100 includes a cavity 50, the metal stripline further includes a signal input terminal (not shown) and a signal output terminal (not shown), the metal stripline 20 is fastened in the cavity 50, and the transmission section is suspended in the cavity 50. The signal input terminal and the signal output terminal are configured to electrically connect to a cable outside the cavity, and the first dielectric plate 10 and the second dielectric plate 30 are disposed in the cavity 50 and are movable relative to the transmission section of the metal stripline 20. The cavity 50 is a hollow rectangle, and two ends of the cavity are provided with openings. A pull rod 40 is further disposed at an end portion of the first dielectric plate 10 or the second dielectric plate 30, and is configured to pull the first dielectric plate 10 and the second dielectric plate 30 to slide. It should be noted that the cable passes through the cavity from the outside and is connected to the cavity, the cable includes an inner conductor and an outer conductor, the outer conductor is welded to a hole of the cavity, the inner conductor is configured to electrically connect to a corresponding signal input terminal and a corresponding signal output terminal, and the cable is configured to output and input a signal.

In an embodiment, a signal that needs to be radiated out is transmitted to the cavity 50 via the signal input terminal, and is transmitted to the signal output terminal along the direction of the metal stripline 20 via a medium in the cavity 50. The medium in the cavity 50 includes the first dielectric plate 10 and the second dielectric plate 30 that are laminated on a surface of the metal stripline 20, and air around the metal stripline 20. When the first dielectric plate 10 and the second dielectric plate 30 move along the metal stripline 20, an equivalent dielectric constant of a medium in a transmission section between the signal input terminal and the signal output terminal changes, so that a phase of a signal transmitted from the signal output terminal changes. For example, before the first dielectric plate 10 and the second dielectric plate 30 move, the medium in the transmission section includes only air between the metal stripline 20 and the cavity 50. After the first dielectric plate 10 and the second dielectric plate 30 move by a distance, the first dielectric plate 10 and the second dielectric plate 30 move to the transmission section. Therefore, the medium in the transmission section includes the first dielectric plate 10, the second dielectric plate 30, and air between the metal stripline 20 and the cavity 50 in the transmission section, so that the equivalent dielectric constant of the medium in the transmission section changes, and the phase of the signal output by the signal output terminal changes. In addition, when the first dielectric plate 10 and the second dielectric plate 30 are continuously moved, areas of the first dielectric plate 10 and the second dielectric plate 30 in the transmission section change continuously, even if the equivalent dielectric constant of the medium in the transmission section changes, and finally the phase of the signal output by the signal output terminal can be continuously changed. Therefore, in this application, the first dielectric plate 10 and the second dielectric plate 30 can be moved by a distance based on an actual requirement, so that a radiated signal has a required phase.

Further, in an embodiment, the transmission section of the metal stripline 20 is suspended in the cavity 50, and the metal stripline 20 does not need to be disposed on a substrate, thereby reducing signal energy loss caused by the substrate and increasing a gain of the remote electrical tilt antenna. In addition, heat generated due to the signal energy loss can be reduced, thereby lowering a requirement of the phase shifter 100 for heat dissipation and heat resistance performance of an internal structural part, and enhancing temperature resistance reliability of each structure in the remote electrical tilt antenna.

As shown in FIG. 3, further, the first dielectric plate 10 includes a first side surface 104 and a second side surface 103, the second dielectric plate 30 includes a third side surface 303 and a fourth side surface 304. An abutting protrusion 32 (12) protrudes on each of the first side surface 104 and the third side surface 303. The cavity 50 includes two opposite cavity walls. The first dielectric plate 10 and the second dielectric plate 30 slide in the cavity 50, and the abutting protrusion 32 (12) slides along the cavity wall. It may be understood that the abutting protrusion 32 (12) is just in contact with the cavity wall of the cavity 50 without affecting sliding, and sliding accuracy of the first dielectric plate 10 and the second dielectric plate 30 can be ensured.

In an embodiment, as shown in FIG. 10, the cavity 50 includes a first sidewall and a second sidewall (not shown) that are opposite to each other and that extend along the length direction of the metal stripline 20. Two guide grooves 52 and 53 are provided on both the first sidewall and the second sidewall. Two opposite sides of the first dielectric plate 10 are slidably mounted in one guide groove 52 on the first sidewall and the second sidewall, and two opposite sides of the second dielectric plate 30 are slidably mounted in the other guide groove 53 on the first sidewall and the second sidewall. The guide grooves can guide the first dielectric plate 10 and the second dielectric plate 30 mounted inside the guide grooves, so that the first dielectric plate 10 and the second dielectric plate 30 can slide along the guide grooves without deviation. In addition, the guide grooves can also limit the first dielectric plate 10 and the second dielectric plate 30, so that both the first dielectric plate 10 and the second dielectric plate 30 can only deviate within the guide grooves in the height direction and the width direction. The deviations of the first dielectric plate 10 and the second dielectric plate 30 relative to the metal stripline 20 in the height direction and the width direction are small, which can further enhance accurate control of the phase change by the phase shifter 100.

The above are merely some embodiments and implementations of this application, and are not intended to limit the protection scope of this application. Any variations or replacements readily figured out by a person skilled in the art within the technical scope disclosed in this application. The variations or replacements shall fall within the protection scope of this application. Therefore, the protection scope of this application should be subject to the protection scope of the claims.

What is claimed is:

1. A phase shifter, comprising:
a metal stripline having a main body and a transmission section connected to the main body,
a first dielectric plate, and
a second dielectric plate, wherein the metal stripline is clamped between the first dielectric plate and the second dielectric plate, the first dielectric plate and the second dielectric plate slide relative to the metal stripline along a length direction of the metal stripline, at least one limiting protrusion protrudes along the length direction on a surface of the first dielectric plate and/or the second dielectric plate facing the metal stripline, the at least one limiting protrusion is opposite to a side portion of the metal stripline, and wherein the at least one limiting protrusion is configured to limit displacement of the first dielectric plate and the second dielectric plate relative to the metal stripline when the first dielectric plate and the second dielectric plate slide.

2. The phase shifter according to claim 1, wherein when the first dielectric plate and the second dielectric plate slide relative to the metal stripline, the at least one limiting protrusion moves along the side portion of the metal stripline, and an extension direction of the side portion is the same as the length direction.

3. The phase shifter according to claim 1, wherein the at least one limiting protrusion limits displacement of the first dielectric plate and the second dielectric plate relative to the metal stripline in a width direction, and the width direction is perpendicular to the length direction.

4. The phase shifter according to claim 3, wherein the at least one limiting protrusion protrudes on the first dielectric plate, each of the limiting protrusions comprises a body connected to the first dielectric plate and a limiting body located at an end portion of the body, the limiting body protrudes on one side of the body and extends towards the width direction, and the limiting body is located on a surface of the metal stripline facing away from the first dielectric plate.

5. The phase shifter according to claim 3, wherein a straight-line distance between a surface of the at least one limiting protrusion facing the metal stripline and the side portion of the metal stripline is greater than 0 millimeters (mm) and less than or equal to 1 mm.

6. The phase shifter according to claim 1, wherein the at least one limiting protrusion comprises a plurality of limiting protrusions located on one side of a surface of the first dielectric plate and/or the second dielectric plate and disposed at intervals along the length direction, or
the plurality of limiting protrusions are located on two opposite sides of a surface of the first dielectric plate and/or the second dielectric plate and disposed in pairs, or
the plurality of limiting protrusions are located on two opposite sides of a surface of the first dielectric plate and/or the second dielectric plate and disposed in a staggered manner.

7. The phase shifter according to claim 1, wherein the limiting protrusion protrudes on the first dielectric plate, a groove is provided on a surface of the second dielectric plate opposite to the first dielectric plate, the first dielectric plate is connected to the second dielectric plate, and the limiting protrusion extends into the groove and is held and fastened in the groove, or
the limiting protrusion is a hook, the limiting protrusion protrudes on the first dielectric plate, a slot is provided on a surface of the second dielectric plate opposite to the first dielectric plate, the first dielectric plate is connected to the second dielectric plate, and the hook is held in the slot.

8. The phase shifter according to claim 1, wherein the phase shifter comprises a cavity, the metal stripline comprises a signal input terminal and a signal output terminal, the metal stripline is fastened in the cavity, and the transmission section is suspended in the cavity; and the signal input terminal and the signal output terminal are configured to electrically connect to a cable outside the cavity, and the first dielectric plate and the second dielectric plate are disposed in the cavity and are movable relative to the transmission section of the metal stripline.

9. The phase shifter according to claim 8, wherein the transmission section comprises a first transmission section and a second transmission section, a gap extending along the length direction is formed between the first transmission section and the second transmission section, a buckle is disposed on the first dielectric plate, and a slot is provided at a position of the second dielectric plate relative to the buckle, and the buckle passes through the gap and is held in the slot, and the buckle slides in the gap, so that the first dielectric plate and the second dielectric plate slide in a same direction relative to the metal stripline.

10. The phase shifter according to claim 9, wherein the first dielectric plate comprises a first side surface and a second side surface, the second dielectric plate comprises a third side surface and a fourth side surface, an abutting protrusion protrudes on each of the first side surface and the third side surface or on each of the second side surface and the fourth side surface, the cavity comprises two opposite cavity walls, the first dielectric plate and the second dielectric plate slide in the cavity, and the abutting protrusions slide along the cavity walls.

11. The phase shifter according to claim 8, wherein the cavity comprises a first sidewall and a second sidewall, opposite to each other and extending along the length direction of the metal stripline, two guide grooves are provided on each of the first sidewall and the second sidewall, and two opposite sides of the first dielectric plate are slidably mounted in one of the guide grooves on the first sidewall and the second sidewall, and two opposite sides of the second dielectric plate are slidably mounted in another guide groove on the first sidewall and the second sidewall.

12. A remote electrical tilt antenna, comprising:
a radiating element; and
a phase shifter, wherein the radiating element is connected to the phase shifter, and an electromagnetic wave signal transmitted by the phase shifter is radiated out through the radiating element, wherein the phase shifter comprises:
a metal stripline having a main body and a transmission section connected to the main body,
a first dielectric plate, and
a second dielectric plate, wherein the metal stripline is clamped between the first dielectric plate and the second dielectric plate, the first dielectric plate and the second dielectric plate slide relative to the metal stripline along a length direction of the metal stripline, at least one limiting protrusion protrudes along the length direction on a surface of the first dielectric plate and/or the second dielectric plate facing the metal stripline, the at least one limiting protrusion is opposite to a side portion of the metal stripline, and wherein the at least one limiting protrusion is configured to limit displacement of the first dielectric plate and the second dielectric plate relative to the metal stripline when the first dielectric plate and the second dielectric plate slide.

13. The remote electrical tilt antenna according to claim 12, wherein when the first dielectric plate and the second dielectric plate slide relative to the metal stripline, the at least one limiting protrusion moves along the side portion of the metal stripline, and an extension direction of the side portion is the same as the length direction.

14. The remote electrical tilt antenna according to claim 12, wherein the at least one limiting protrusion limits displacement of the first dielectric plate and the second dielectric plate relative to the metal stripline in a width direction, and the width direction is perpendicular to the length direction.

15. The remote electrical tilt antenna according to claim 14, wherein the at least one limiting protrusion protrudes on the first dielectric plate, each of the limiting protrusions comprises a body connected to the first dielectric plate and a limiting body located at an end portion of the body, the limiting body protrudes on one side of the body and extends towards the width direction, and the limiting body is located on a surface of the metal stripline facing away from the first dielectric plate.

16. The remote electrical tilt antenna according to claim 14, wherein a straight-line distance between a surface of the at least one limiting protrusion facing the metal stripline and the side portion of the metal stripline is greater than 0 millimeters (mm) and less than or equal to 1 mm.

17. The remote electrical tilt antenna according to claim 12, wherein the at least one limiting protrusion comprises a plurality of limiting protrusions located on one side of a surface of the first dielectric plate and/or the second dielectric plate and disposed at intervals along the length direction, or
the plurality of limiting protrusions are located on two opposite sides of a surface of the first dielectric plate and/or the second dielectric plate and disposed in pairs, or
the plurality of limiting protrusions are located on two opposite sides of a surface of the first dielectric plate and/or the second dielectric plate and disposed in a staggered manner.

18. The remote electrical tilt antenna according to claim 12, wherein the limiting protrusion protrudes on the first dielectric plate, a groove is provided on a surface of the second dielectric plate opposite to the first dielectric plate, the first dielectric plate is connected to the second dielectric plate, and the limiting protrusion extends into the groove and is held and fastened in the groove, or
the limiting protrusion is a hook, the limiting protrusion protrudes on the first dielectric plate, a slot is provided on a surface of the second dielectric plate opposite to the first dielectric plate, the first dielectric plate is connected to the second dielectric plate, and the hook is held in the slot.

19. The remote electrical tilt antenna according to claim 12, wherein the phase shifter comprises a cavity, the metal stripline comprises a signal input terminal and a signal output terminal, the metal stripline is fastened in the cavity, and the transmission section is suspended in the cavity; and the signal input terminal and the signal output terminal are configured to electrically connect to a cable outside the cavity, and the first dielectric plate and the second dielectric plate are disposed in the cavity and are movable relative to the transmission section of the metal stripline.

20. The remote electrical tilt antenna according to claim 19, wherein the transmission section comprises a first transmission section and a second transmission section, a gap extending along the length direction is formed between the first transmission section and the second transmission section, a buckle is disposed on the first dielectric plate, and a slot is provided at a position of the second dielectric plate relative to the buckle, and the buckle passes through the gap and is held in the slot, and the buckle slides in the gap, so that the first dielectric plate and the second dielectric plate slide in a same direction relative to the metal stripline.
